(19) United States
(12) Patent Application Publication
(10) Pub. No.: US 2009/0322784 A1
(43) Pub. Date: Dec. 31, 2009

(54) SYSTEM AND METHOD FOR VIRTUAL 3D GRAPHICS ACCELERATION AND STREAMING MULTIPLE DIFFERENT VIDEO STREAMS

(76) Inventor: Gabriele Sartori, Fremont, CA (US)

Correspondence Address: SCHWEGMAN, LUNDBERG & WOESSNER, P.A., P.O. BOX 2938, MINNEAPOLIS, MN, 55402, US

(21) Appl. No.: 12/395,130

(22) Filed: Feb. 27, 2009

Related U.S. Application Data
(60) Provisional application No. 61/032,045, filed on Feb. 27, 2008.
(60) Provisional application No. 61/199,826, filed on Nov. 19, 2008.

(51) Int. Cl. G09G 5/00; H04N 7/173; G06F 15/16

(52) U.S. Cl. 345/619; 725/93; 709/231

(57) ABSTRACT

A digital video transmission system that improves performance using 3D graphics acceleration hardware. A first system creates a virtual 3D graphics card for each terminal session executing on a server system that supports multiple users. The virtual 3D graphics card is assigned a share of processing ability on a physical 3D graphics accelerator. The virtual 3D graphics card uses the share of processing ability on the physical 3D graphics accelerator to render 3D graphics in a local screen buffer associated with the terminal session. The local screen buffer is encoded and transmitted to a remote display that recreates the screen display in a video buffer of remote display. A second system operates by using a physical 3D graphics accelerator in a server system to perform transcoding for multiple video streams. To best perform task switching, the task switching is performed on I-frame borders.

### CROSS REFERENCE TO RELATED APPLICATIONS

This application claims the benefit of U.S. Provisional Patent Application Ser. No. 61/032,045 filed Feb. 27, 2008 (“METHOD FOR VIRTUAL 3D GRAPHICS ACCELERATION”) and U.S. Provisional Patent Application Ser. No. 61/199,826 filed Nov. 19, 2008 (“SYSTEM AND METHOD FOR STREAMING MULTIPLE DIFFERENT VIDEO STREAMS”), both of which are incorporated herein by reference in their entirety.

### TECHNICAL FIELD

The present invention relates to the field of video processing and video encoding. In particular, but not by way of limitation, the present invention discloses techniques for allowing multiple local video images to be created locally and then encoded for transmission to a remote location in an efficient manner.

### BACKGROUND

Centralized computer systems with multiple terminal systems for accessing the centralized computer systems were once the dominant computer architecture. These mainframe or mini-computer systems were shared by multiple computer users wherein each computer user had access to a terminal system coupled to the mainframe computer.

In the late 1970s and early 1980s, semiconductor microprocessors and memory devices allowed the creation of inexpensive personal computer systems. Personal computer systems revolutionized the computing industry by allowing each individual computer user to have access to their own full computer system. Each personal computer user could run their own software applications and did not need to share any of the personal computer's resources with any other computer user.

Although personal computer systems have become the dominant form of computing, there has been a resurgence of the centralized computer with multiple terminals form of computing. Terminal systems can have reduced maintenance costs since terminal users cannot easily introduce viruses into the main computer system or load in unauthorized computer programs. Furthermore, modern personal computer systems have become so powerful that the computing resources in these modern personal computer systems generally sit idle for the vast majority of the time.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a diagrammatic representation of machine in the example form of a computer system within which a set of instructions, for causing the machine to perform any one or more of the methodologies discussed herein, may be executed.

FIG. 2A illustrates a high-level block diagram of one embodiment of a thin-client terminal system coupled to a thin-client server computer system.

FIG. 2B illustrates a high-level block diagram of a single thin-client server computer system supporting multiple individual thin-client terminal systems using a local area network.

FIG. 3 illustrates a high-level flow diagram of how a 3D graphics accelerator may be used within a terminal server system.

FIG. 4A illustrates a more detailed flow diagram of how a terminal server system may use a 3D graphics accelerator to accelerate 3D graphics applications run on a remote terminal server system.

FIG. 4B that illustrates a block diagram of a thin-client server system using virtual 3D graphics cards to support multiple thin-client terminal systems.

FIG. 5 illustrates the thin-client environment with a GPU based video transcoding system.

FIG. 6 illustrates a flow diagram describing the operation of the system illustrated in FIG. 5.

FIG. 7 illustrates the thin-client environment with a GPU based video transcoding system.

FIG. 8 conceptually illustrates a series of video frames.

FIG. 9 conceptually illustrates how two video streams can be divided into video chunks for transcoding.

### DETAILED DESCRIPTION

The following detailed description includes references to the accompanying drawings, which form a part of the detailed description. The drawings show illustrations in accordance with example embodiments. These embodiments, which are also referred to herein as “examples,” are described in enough detail to enable those skilled in the art to practice the invention. It will be apparent to one skilled in the art that specific details in the example embodiments are not required in order to practice the present invention.

This document will focus on exemplary embodiments that are mainly disclosed with reference to multiple thin-client terminal systems sharing a main server system. However, the teachings of this document can be used in other environments. For example, a video distribution system that distributes multiple different video feeds to multiple different video display systems could use the teachings of this document. The example embodiments may be combined, other embodiments may be utilized, or structural, logical and electrical changes may be made without departing from the scope what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Computer Systems

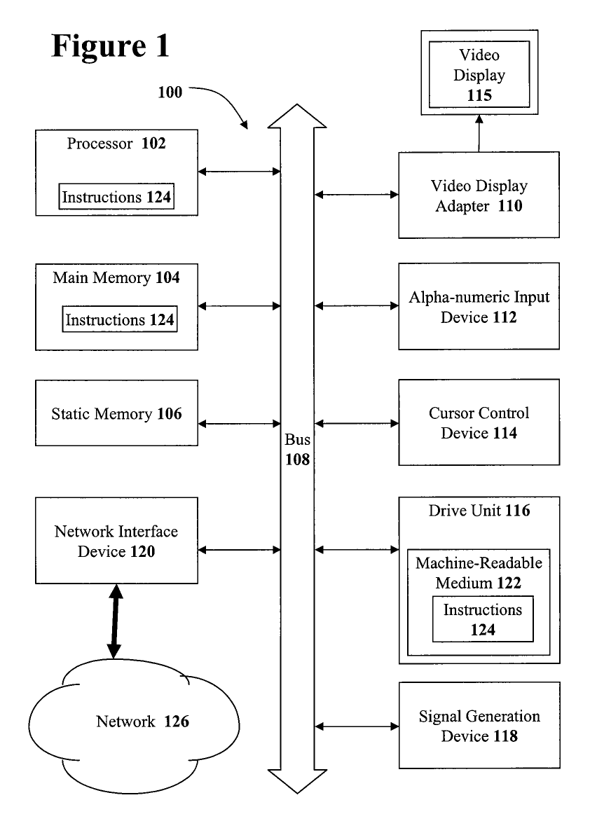

The present disclosure concerns digital video encoding that may be performed with digital computer systems. FIG. 1 illustrates a diagrammatic representation of machine in the example form of a typical digital computer system 100 that may be used to implement portions of the present disclosure.

Within computer system 100 there are a set of instructions 124 that may be executed for causing the machine to perform any one or more of the methodologies discussed herein. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 100 includes a processor 102 (e.g., a central processing unit (CPU), a graphics processing unit (GPU) or both), a main memory 104 and a static memory 106, which communicate with each other via a bus 108. The computer system 100 also includes an alphanumeric input device 112 (e.g., a keyboard), a cursor control device 114 (e.g., a mouse or trackball), a disk drive unit 116, a signal generation device 118 (e.g., a speaker) and a network interface device 120.

In a computer system, such as the computer system 100 of FIG. 1, a video display adapter 110 may drive a local video display system 115 such as a Liquid Crystal Display (LCD), a Cathode Ray Tube (CRT), or other video display device. Currently, most personal computer systems are connected with an analog Video Graphics Array (VGA) connection. Many newer personal computer systems are using digital video connections such as Digital Visual Interface (DVI) or High-Definition Multimedia Interface (HDMI). However, these types of video connections are generally used for short distances. The DVI and HDMI connections require high bandwidth connections.

The disk drive unit 116 includes a machine-readable medium 122 on which is stored one or more sets of computer instructions and data structures (e.g., instructions 124 also known as ‘software’) embodying or utilized by any one or more of the methodologies or functions described herein. The instructions 124 may also reside, completely or at least partially, within the main memory 104 and/or within the processor 102 during execution thereof by the computer system 100, the main memory 104 and the processor 102 also constituting machine-readable media.

The computer instructions 124 may further be transmitted or received over a network 126 via the network interface device 120. Such network data transfers may occur utilizing any one of a number of well-known transfer protocols such as the well known File Transport Protocol (FTP).

While the machine-readable medium 122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies described herein, or that is capable of storing, encoding or carrying data structures utilized by or associated with such a set of instructions. The term “machine-readable medium” shall accordingly be taken to include, but not be limited to, solid-state memories (such as Flash memory), optical media, and magnetic media.

For the purposes of this specification, the term “module” includes an identifiable portion of code, computational or executable instructions, data, or computational object to achieve a particular function, operation, processing, or procedure. A module need not be implemented in software; a module may be implemented in software, hardware/circuitry, or a combination of software and hardware.

Modern Graphics Terminal Systems

Before the advent of the inexpensive personal computer system, the computing industry largely used mainframe or mini-computers that were coupled to many terminals such that the users at the various terminals could share the computer system. Such terminals were often referred to as ‘dumb’ terminals since the actual computing ability resided within the mainframe or mini-computer and the ‘dumb’ terminal merely displayed an output and accepted alpha-numeric input. No computer applications ran locally on the terminal system. Computer operators shared the mainframe computer among the multiple individual users at the individual terminals coupled to the mainframe computer. Most terminal systems generally had very limited graphic capabilities and were mostly only displaying alpha-numeric characters on the local display screen.

With the introduction of the inexpensive personal computer system, the use of dumb terminals rapidly diminished since personal computer systems were much more cost effective. If the services of a dumb terminal were required to interface with a legacy terminal based mainframe or mini-computer system, a personal computer system could easily execute a terminal program that would emulate the operations of a dumb terminal at a cost very similar to the cost of a dedicated dumb terminal.

During the personal computer revolution, personal computers introduced high resolution graphics to personal computer users. Such high-resolution graphic display systems allowed for much more intuitive computer user interfaces than the text-only displays of primitive computer terminals. For example, most personal computer systems now provide high-resolution graphical user interfaces that use multiple different windows, icons, and pull-down menus that are manipulated with an on-screen cursor and a cursor-control input device. Furthermore, multi-color high-resolution graphics allowed for sophisticated applications that used photos, videos, and graphical images.

In recent years, a new generation of terminal devices have been introduced into the computer market. This new generation of computer terminals includes high-resolution graphics capabilities that personal computer users have become accustomed to. These new computer terminal systems allow modern computer users to enjoy the advantages of traditional terminal-based computer systems. For example, computer terminal systems allow for greater security and reduced maintenance costs since users of computer terminals cannot easily introduce computer viruses by downloading or installing new software. Furthermore, most personal computer users do not require the full computing ability provided by modern personal computer systems since interaction with a human user is limited by the human user's relatively slow typing speed.

Modern terminal-based computer systems allow multiple users located at high-resolution terminal systems to share a single personal computer system and all of the software installed on that single personal computer system. In this manner, a modern high-resolution terminal system is capable of delivering the functionality of a personal computer system to multiple users without the cost and the maintenance requirements of having a personal computer system for each user. A category of these modern terminal systems is called “thin client” systems. Although the techniques set forth this document will mainly be disclosed with reference to thin-client systems, the techniques described herein are applicable in other area of the IT industry as well.

A Thin-Client System

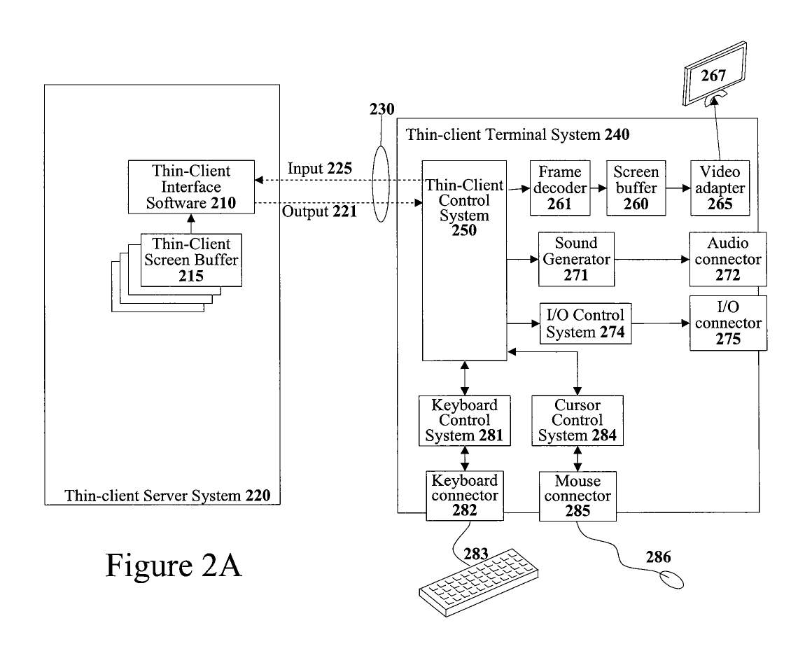

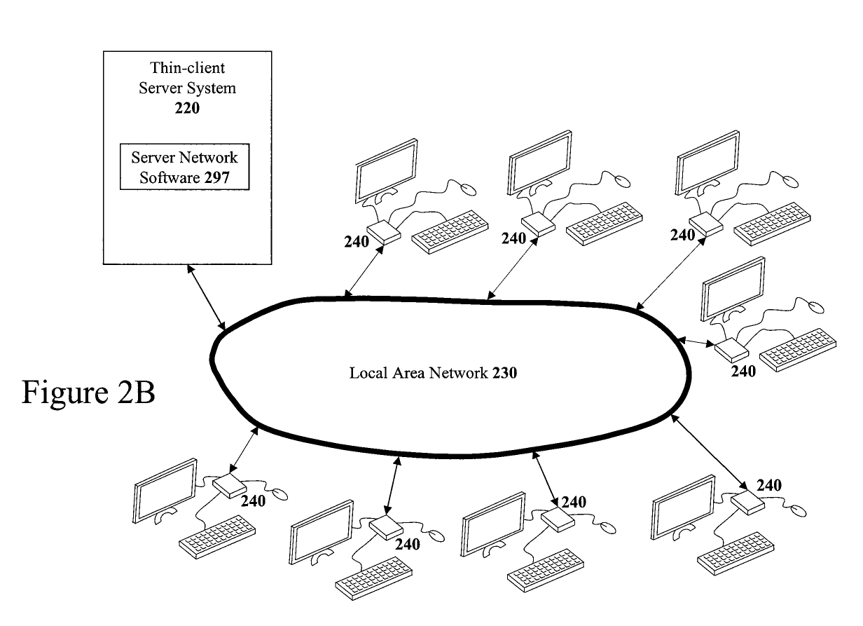

FIG. 2A illustrates a high-level block diagram of one embodiment of a thin-client server system 220 coupled to one thin-client terminal system 240 of several thin-client terminal systems that may be coupled to the. thin-client server computer system 22 The thin-client server system 220 and thin-client terminal system 240 are coupled together with a communications channel 230 that may be a serial data connection, an Ethernet connection, or any other suitable bi-directional digital communication means that allows the thin-client server system 220 and thin-client terminal system 240 to communicate.

FIG. 2B illustrates a conceptual diagram of a thin-client environment wherein a single thin-client server computer system 220 provides computer resources to many thin-client terminal systems 240. In the embodiment of FIG. 2B, each of the individual thin-client terminal systems 240 are coupled to the thin-client server computer system 220 using local area network 230 as a communication channel.

The goal of each thin-client terminal system 240 is to provide most or all of the standard input and output features of a personal computer system to a user of the thin-client terminal system 240. However, in order to be cost-effective, this goal is to be done without providing the full computing resources or software of personal computer system in the thin-client terminal system 240 since those features will be provided by the thin-client server system 220 that will interact with the thin-client terminal system 240. In effect, each thin-client terminal system 240 will appear to its user as a full personal computer system.

From an output perspective, each thin-client terminal system 240 provides both a high-resolution video display system and an audio output system. Referring to the embodiment of FIG. 2A, the high-resolution video display system in thin-client terminal system 240 consists of a frame decoder 261, a screen buffer 260, and a video adapter 265. The video frame decodes video information and places that video information into screen buffer 260. Screen buffer 260 contains the contents of a bit-mapped display. Video adapter 265 reads the display information out of screen buffer 260 and generates a video display signal to drive display system 267 (such as an LCD display or video monitor). The screen buffer 260 is filled with display information provided by thin-client control system 250 using video information sent as output 221 by the thin-client server system 220 across a communications channel 230. Similarly, the audio system consists of a sound generator 271 coupled to an audio connector 272 for creating a sound signal with information provided by thin-client control system 250 using audio information sent as output 221 sent by the thin-client server system 220 across a communications channel 230.

From an input perspective, thin-client terminal system 240 of FIG. 2A allows for both alpha-numeric input and cursor control input from a user. The alpha numeric input is provided by a keyboard 283 coupled to a keyboard connector 282 that supplies signals to a keyboard control system 281. Thin-client control system 250 encodes keyboard input from keyboard control system 281 and sends that keyboard input as input 225 to the thin-client server system 220. Similarly, the thin-client control system 250 encodes cursor control input from cursor control system 284 and sends that cursor control input as input 225 to the thin-client server system 220.

The thin-client terminal system 240 may include other input, output, or combined input/output systems in order to provide additional functionality. For example, the thin-client terminal system 240 of FIG. 2A includes input/output control system 274 coupled to input/output connector 275. Input/output control system 274 may be a Universal Serial Bus (USB) controller and input/output connector 275 may be a USB connector in order to provide USB capabilities to thin-client terminal system 240.

The thin-client server system 220 is equipped with software for detecting coupled thin-client terminal systems 240 and interacting with the detected thin-client terminal systems 240 in a manner that allows each thin-client terminal system 240 to appear as an individual person computer system. As illustrated in FIG. 2A, thin-client interface software 210 in thin-client server system 220 supports thin-client terminal system 240 as well as any other thin-client terminal systems coupled to thin-client server system 220. Each thin client terminal system will have its own screen buffer in the thin-client server system 220 such as thin-client terminal screen buffer 215.

Transporting Video Information to Terminal Systems

The communication channel 230 bandwidth required to deliver a continuous sequence of digital video frames from the thin-client server computer system 220 to thin-client terminal system 240 can quite large. In an environment wherein a shared computer network is used to transport video information to several thin-client terminal systems 240 (such as the thin-client terminal system environment illustrated in FIG. 2B), a large amount of video information can adversely impact the computer network by saturating it with data packets carrying video display information.

When the computer applications run by the user of the thin-client terminal systems 240 are typical office work applications (word processors, databases, spreadsheets, etc.) that change the information on the display screen on a relatively infrequent basis, then there are simple methods that can be used to greatly decrease the amount of video display information delivered over the network while maintaining a high-quality user experience. For example, the thin-client server system 220 may only send video information across the communication channel 230 to a thin-client terminal system 240 when that video information changes. In this manner, when the video display screen for a particular thin-client terminal system 240 is static, then no video information needs to be transmitted from the thin-client server system 220 to that thin-client terminal system 240.

Three-Dimensional Graphics

Once reserved for very high end workstations, hardware-based three-dimensional (3D) graphics technology is now available for personal computers including the economical and portable models. The widespread availability of hardware-based 3D graphics technology has made 3D graphics hardware ubiquitous in personal computer hardware and many applications utilize the 3D graphics hardware. For example, the video display adapter 110 of FIG. 1 would normally contain a 3D graphics chip to provide the computer system 100 with 3D graphics acceleration. Thus, end users of personal computers generally consider 3D graphics technology a checklist item and its availability is taken for granted. Unfortunately, there are some cases where it is a challenge to offer 3D graphics technology. Specifically, in a thin-client based environment as illustrated in FIGS. 2A and 2B, it is difficult to provide the users of the thin-client terminal systems with a good 3D graphics experience.

In an example embodiment, a method of providing improved 3D graphics support for terminal systems is disclosed that may rely on 3D graphics hardware already existing in the physical server machine where the virtual machine or terminal server is running. A terminal server is a server application that interfaces a multitude of remote terminal systems. The terminal server application shares the resources of a single server, creating a graphic interface dedicated to each terminal session as illustrated in FIGS. 2A and 2B. In the computer system 100 of FIG. 1 were used as a terminal server system, a 3D graphics chip within video display adapter 110 could be used to provide 3D graphics acceleration for the terminal sessions handled by the computer system 100.

Most modern personal computers have a graphics chip with at least some 3D graphics technology features. These 3D graphics chips generally maintain both three-dimensional and two-dimensional representations of a screen. The three-dimensional representation may be a set of 3D object models and the coordinates and orientation of those object models within a three-dimensional space. The two 2D representation is how the three-dimensional object models would appear to a viewer in that three-dimensional space placed at a defined set of coordinates and with a defined viewing direction.

Example uses of three-dimensional graphics technology include high-end drawing functionality such as computer-aided design (CAD) and consumer products such as high-end video games. In 3D games, a 3D scene is updated in real time based upon a user's actions and the updated 3D scene is rendered into a 2D memory buffer. The 3D graphics hardware is used to aid the computer system in rendering the 2D representation from the 3D representation The 2D buffer has the exact representation of what is displayed on the display screen attached to the computer system with 3D graphics hardware.

Much of the time, the powerful 3D graphics chips within a personal computer system are not being used for CAD or high-end video games. In fact, most personal computer users only require of a small portion of the computing potential in the personal computer. In an example embodiment, the 3D graphics system in a computer system is configured to render 3D graphics on multiple different virtual screens thus sharing the 3D rendering capabilities of one 3D graphics chip with multiple users on the same computer system. This embodiment may be deployed for users on virtual machines as well users on terminal servers.

Drivers are provided for allowing a single 3D graphics processing hardware device to create multiple different “virtual 3D graphic cards”. In this document, a virtual 3D graphics card is a software entity that acts as a 3D graphics card for a terminal session. Each virtual 3D graphics card may or may not use the features of a real 3D graphics hardware device in a system. In example embodiments, a virtual 3D graphics card instance is created when either a new terminal session or a new virtual machine is launched. The new virtual 3D graphics card instance will pretend to be a physical 3D graphics card for the terminal session or virtual machine that may use a share of the physical 3D graphics hardware in the server system.

In an example embodiment, a system with many terminal server sessions or virtual machines each having a virtual 3D graphics card may be configured. Usually, only a few of the terminal sessions will actually require 3D rendering. However, in an example embodiment, sharing the physical 3D graphics hardware with multiple users running 3D applications may lower the frame rate for each terminal server but still delivers a good user experience. Each terminal session initiated may be associated with one or more threads of a plurality threads provided in the 3D graphics hardware.

Various different schemes may be used to share a 3D graphics chip among multiple terminal sessions. In one example embodiment, a context switching architecture is implemented. For example, the entire graphics pipeline may be executed for one terminal session and then flushed before context switching to another terminal session occurs.

In another example embodiment, the 3D graphics pipeline may be segmented. In such an embodiment, each pipeline segment may have an independent job such that task switching is performed on the pipeline segment scale.

The 3D graphics chip, in accordance with an example embodiment, may have a single or multiple 2D frame buffers. In an example embodiment, a “multi-head” 3D graphic chip is provided that supports multiple 2D frame buffers. The number of independent 2D frame buffers supported by a 3D graphics chip can be limited. In these cases, memory management may be implemented to swap 2D frame buffers when terminal sessions are switched.

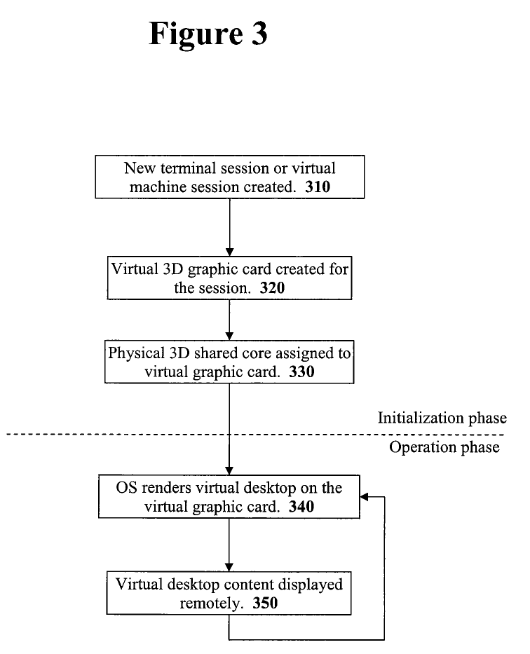

FIG. 3 illustrates a high-level overview of a method, in accordance with an example embodiment, for 3D graphics processing including a plurality of threads or GPU modules provided on a single core. Initially, at stage 310, the method creates a new terminal server (TS) or virtual machine (VM) session. Thereafter, a virtual 3D graphics card is created for that new session at stage 320. A physical 3D shared core may then be assigned to the virtual graphics card at stage 330. The physical core may be shared in a time-sharing manner. At this point, an initialization phase is complete.

Once the operation phase begins, the operating system on the terminal server system (under direction of the terminal session) may then render a virtual desktop using the virtual 3D graphics card at stage 340. The virtual 3D graphics card will render the virtual desktop in a 2D frame buffer. The virtual desktop content may then be displayed remotely by transmitting information from the 2D buffer at stage 350. For example, the display information in the frame buffer may be transmitted to a networked thin-client terminal system which may or may not include a CPU.

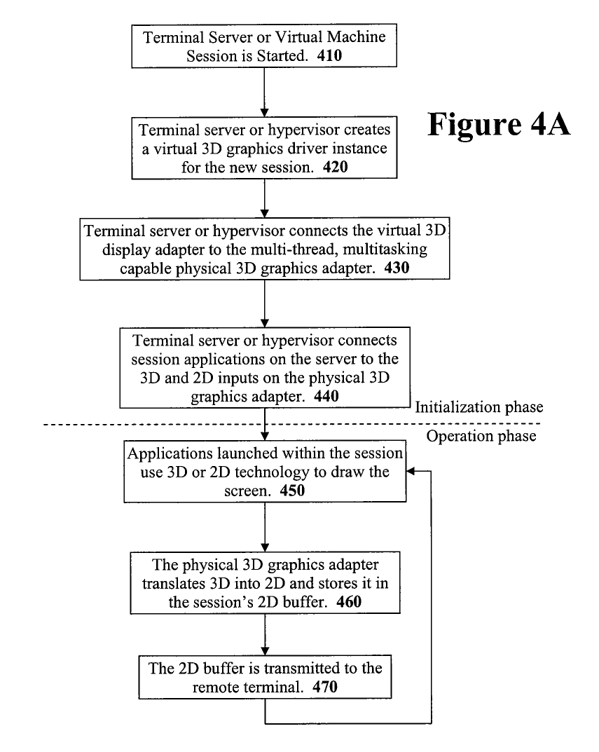

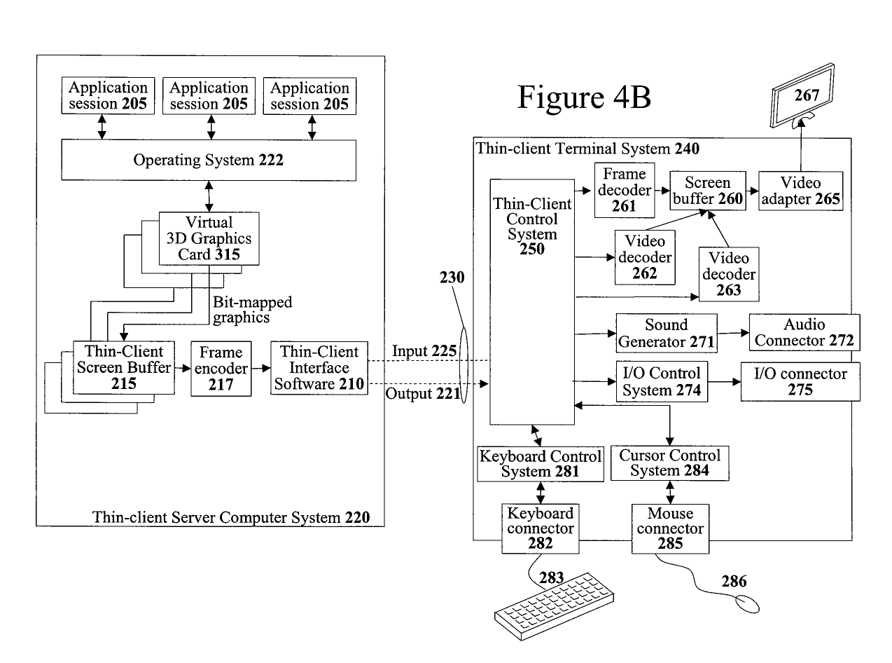

FIG. 4A illustrates a more detailed method, in accordance with an example embodiment, for virtual 3D graphics acceleration. FIG. 4A will be described with reference to FIG. 1 that illustrates a generic computer system that may operate as a server system and FIG. 4B that illustrates a block diagram of a thin-client server system which uses a virtual 3D graphics card to serve thin-client terminal systems.

Referring to FIG. 4A, a terminal session or Virtual Machine session may be started on a thin-client server system (e.g., a server serving a plurality of thin clients) at stage 410. In FIG. 4B, the terminal session or virtual machine session is illustrated as an application session 205. The new terminal session may be associated with a thin-client terminal system 240 connected to the thin-client server system 220 via a network 230. Next, at stage 420, a terminal server program or hypervisor may create a virtual 3D graphics card instance for the new session. This is illustrated in FIG. 4B as a virtual 3D graphics card 315. Note that each virtual 3D graphics card 315 has its own associated 2D screen buffer 215 for storing a representation of the screen display of the associated thin-client terminal system 240.

Next, at stage 430, the terminal server or hypervisor may connect the virtual 3D graphics card 315 to the multi-thread, multi-tasking capable physical 3D graphics chip on the graphics adapter 110 of the server system. This connection may be done in a time-sharing manner such that each virtual 3D graphics card 315 only gets a time slice of the physical 3D graphics chip on the graphics adapter 110. The terminal server or hypervisor may also connect the application session to the inputs of the physical 3D graphics chip on the graphics adapter 110 through the virtual 3D graphics adapter 315 at stage 440. At this point, the initialization for the new session is complete.

Applications may then be launched within the session using 3D or 2D technology to draw the screen (e.g., a desktop image for a local or remote display device) at stage 450. The applications will use the virtual 3D graphics adapter 315. At stage 460, the virtual 3D graphics adapter 315 will access the physical 3D graphics chip to translate a 3D scene model into a 2D representation and store the translated result in 2D screen buffer 215 associated with the session and virtual 3D graphics adapter 315. The 2D screen buffer 215 may then be transmitted to the associated thin-client terminal 240 as set forth in stage 470. As illustrated in FIG. 4B, this may be performed by the frame buffer encoder 217 that encodes display information and the thin-client interface software 210 that transmits information to the thin-client terminal system 240.

In another example embodiment, multiple virtual 3D graphics accelerators are provided using a plurality of threads in a GPU. Each thread may be assigned to a session associated with a networked terminal device. In an example the networked terminal device may be a thin client which may or may not include a CPU. In an example embodiment, each session has a fully assigned thread and processing is not shared with other threads. Thus processing of different session with different terminal devices may not be shared. The 2D image data from the server system may be communicated to the networked terminal system using TCP/IP or any other network protocol.

Difficulty of Transporting Full Motion Video Information to Terminal Systems

Referring back to FIG. 2A, as long as the computer applications being run by a user of a thin-client terminal system 240 do not change the information on the display screen very frequently, a thin-client server system that only transmits changes in the thin-client screen buffer 215 to the thin-client terminal system 240 will work adequately. However, if some users of thin-client terminal systems 240 run display intensive applications that frequently change the display screen image, such as applications that display full-motion video, then the volume of traffic communication channel 230 will increase greatly due the constantly changing screen display. If several users of thin-client terminal systems 240 run applications that display full-motion video then the communication channel 230 bandwidth requirements can become quite formidable such that data packets on the communication channel 230 may be dropped. Thus, a different scheme would be desirable for transmitting full-motion video information to thin-client terminal systems 240.

When full motion video must be transmitted digitally, video compression systems are generally used in order to greatly reduce the amount of bandwidth needed to transport the video information. Thus, a digital video decoder may be implemented in thin-client terminal systems 240 in order to reduce the communication channel bandwidth used when a user executes an application that displays full-motion video.

Video compression systems generally operate by taking advantage of the temporal and spatial redundancy in nearby video frames. For efficient digital video transmission, video information is encoded (compressed) at a video origination site, transmitted in encoded form across a digital communication channel (such as a computer network), decoded (decompressed) at the destination site, and then displayed on a display device at the destination site. Many well-known digital video encoding systems exist such as MPEG-1, MPEG-2, MPEG-4, and H.264. These various digital video encoding systems are used to encode DVDs, digital satellite television, and digital cable television broadcasts.

Implementing digital video encoding and video decoding systems is relatively easy on a modern personal computer system that is dedicated to a single user since there is plenty of processing power and memory capacity available for the task. However, in a multi-user thin-client terminal system environment as illustrated in FIG. 2B, the resources of a single thin-client server system 220 must be shared among multiple users at thin-client terminal systems 240. Thus, it would be very difficult for the single thin-client server system 220 to encode digital video for multiple users at different thin-client terminal systems 240 without quickly becoming overloaded.

Similarly, one of the primary goals for a multi-user thin-client system is to keep the construction of the thin-client terminal systems 240 as simple and inexpensive as possible. Thus, constructing a thin-client terminal system with a main computer processor with sufficient processing power to handle digital video decoding in the same manner as it is handled in personal computer system may not be cost efficient. Specifically, a thin-client terminal system 240 that could handle video decoding with generalized processor would require a large amount of memory in order to store the incoming data, storage space for the decoder code, the ability to perform dynamic updates, and sufficient processing power to execute the sophisticated digital video decoder routines such that the thin-client terminal system 240 would become expensive to develop and manufacture.

Integrating Full Motion Video Decoders in Terminal Systems

To efficiently implement full-motion video decoding in thin-client terminal systems, the thin-client terminal systems 240 may be implemented with one or more inexpensive dedicated digital video decoder integrated circuits. Such digital video decoder integrated circuits would relieve a main processor in the thin-client terminal system 240 from the difficult task of video decoding.

Dedicated digital video decoder integrated circuits have become relatively inexpensive due a mass marketplace for digital video devices. For example, DVD players, portable video playback devices, satellite television receivers, cable television receivers, terrestrial high-definition television receivers, and other consumer products must all incorporate some type of digital video decoding circuitry. Thus, a large market of inexpensive digital video decoder circuits has been created. With the addition of one or more inexpensive dedicated video decoder integrated circuits, a thin-client terminal system that is capable of handling digitally encoded video can be implemented at a relatively low cost.

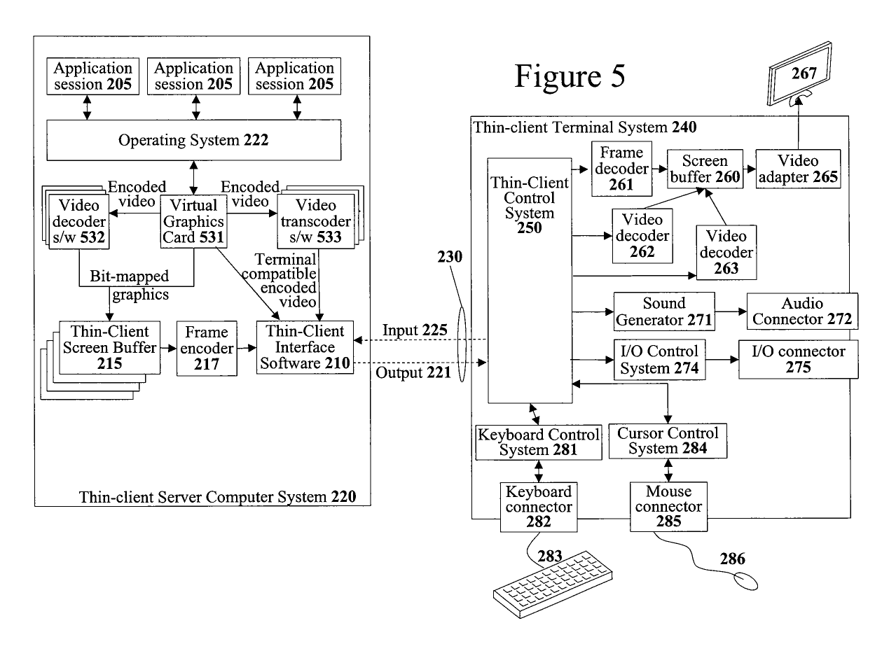

FIG. 5 illustrates a thin-client server 220 and a thin-client terminal system 240 that has been implemented with dedicated video encoders to handle full-motion video. The thin-client terminal system 240 of FIG. 5 is similar to the thin-client terminal system 240 of FIG. 2A except that two dedicated video decoders 262 and 263 have been added to the thin-client terminal system 240. The dedicated video decoders 262 and 263 receive encoded video information from the thin-client control system 250 and render that encoded video information into video frames in the screen buffer 260. The video adapter 265 will convert the video frames in the screen buffer 260 into signals to drive the display system 267 coupled to the thin-client terminal system 240. Alternative embodiments may have only one video decoder or a plurality of video decoders.

The digital video decoders that are selected for implementation within the thin-client terminal system 240 are selected for ubiquity and low implementation cost in a thin-client system architecture. If a particular digital video decoder is ubiquitous but expensive to implement, it will not be practical due to the high cost of the digital video decoder. However, this particular case is generally self-limiting since any digital video decoder that is expensive to implement does not become ubiquitous. If a particular digital video decoder is very inexpensive but decodes a digital video encoding that is only rarely used within a personal computer environment then that digital video decoder will not be selected since it is not worth the cost of adding a digital video decoder that will rarely be used.

Although, dedicated video decoder integrated circuits have been discussed, the video decoders for use in a thin-client terminal system 240 may be implemented with many different methods. For example, the video decoders may be implemented with software that runs on a processor, as discrete off-the-shelf hardware parts, or as decoder cores that are implemented with an Application Specific Integrated Circuit (ASIC) or a Field Programmable Gate Array. In one embodiment, a licensed video decoder as part of an Application Specific Integrated Circuit (ASIC) was selected since other portions of the thin-client terminal system 240 could also be implemented on the same ASIC.

Integrating Full Motion Video Encoders in a Thin-Client Server Systems

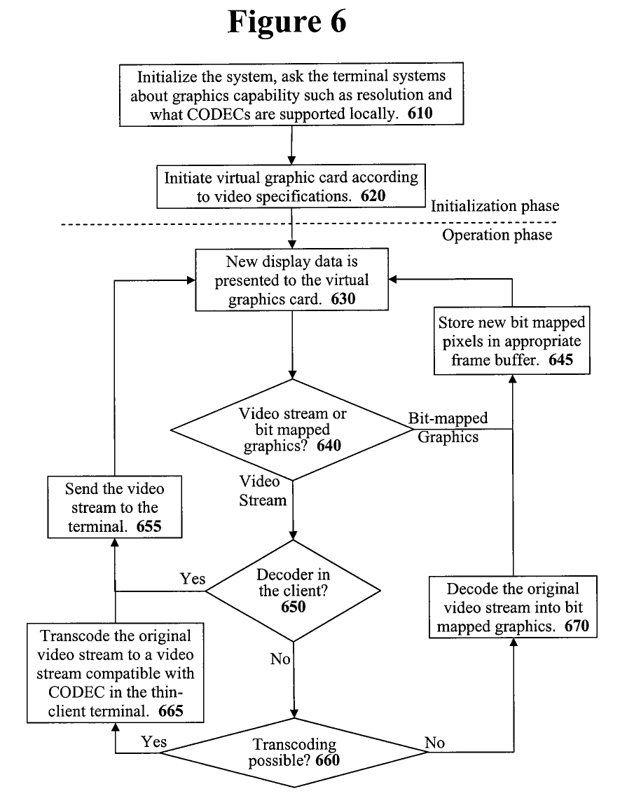

The integration of digital video decoders into thin-client terminal systems only solves a portion of the full-motion video problem, the digital video decoding portion. To take advantage of the integrated digital video decoders, the thin-client terminal server system must be able to transmit encoded video to the thin-client terminal systems. One system for implementing video encoding within a thin-client server system 220 is illustrated in FIG. 5. The operation of the digital video encoding system within the thin-client server system 220 will be described with reference to the flow diagram of FIG. 6.

Referring to FIG. 5, the thin-client server system 220 implements a remote terminal display transmission system that is centered upon a virtual graphics card 531 as described in earlier sections of this document. The virtual graphics card 531 acts as a graphics card for the various application sessions 205 running on the thin-client server system 220. To handle simple display requests from the various application sessions 205, the virtual graphics card 531 response to display requests by modifying the contents of a thin-client screen buffer 215 that contains a representation of the terminal screen display associated with the application session 205.

To help handle full-motion video, the present disclosure supports the virtual graphics card 531 with access to digital video decoders 532 and video digital transcoders 533. The digital video decoders 532 and digital video transcoders 533 are used to handle digital video encoding systems that are not directly supported by the digital video decoder(s) in a target thin-client terminal system 240. Specifically, the video decoders 532 and video transcoders 532 help the virtual graphics card 531 handle digital video encoding streams that are not natively supported by the digital video decoder(s) (if any) in thin-client terminal systems. The decoders 532 are used to decode video streams and place the data thin-client screen buffer 215. The transcoders 533 are used to convert from a first digital video encoding format into a second digital video encoding format. In this case, the second digital video encoding format will be a digital video encoding format natively supported by a target thin-client terminal device.

The transcoders 533 may be implemented as digital video decoder for decoding a first digital video stream into individual decoded video frames, a frame buffer memory space for storing decoded video frames, and a digital encoder for re-encoding the decoded video frames into a second digital video format. This enables the transcoders 533 to use existing video decoders on the personal computer system. Furthermore, the transcoders 533 could share the same video decoding software used to implement video decoders 532. Sharing code would reduce licensing fees.

To best describe video system transport system of the terminal server system 220, its operation will be described with reference to the flow diagram of FIG. 6. Referring to step 610 in FIG. 6, when a new terminal session is created within the thin-client server system 220, the thin-client server system 220 asks the thin-client terminal system 240 to disclose its graphics capabilities. These graphics capabilities may include video configuration information such as the supported display screen resolution(s) and the digital video decoders that the thin-client terminal system 240 supports. This video configuration information received by the thin-client server system 220 from the thin-client terminal system 240 is used to initialize the virtual graphics card 531 for that particular the thin-client terminal system 240 at step 620.

After the terminal session has been initialized and the virtual graphics card 531 has been created, the virtual graphics card 531 is ready to accept display requests from the associated application session 205 and the operating system 222 at step 630 in FIG. 6. When a display request is received in the virtual graphics card 531, the virtual graphics card 531 first determines if the display request is for a full-motion video stream or for bit-mapped graphics. If a bit-mapped graphics request is received then the virtual graphics card 531 simply writes the appropriate bit-mapped pixels into the screen buffer 215 associated with the application session 205 at step 645. The frame encoder 217 of the thin-client server system 220 will read the bit mapped screen buffer 215 and transport the changes to that display information to the associated thin-client terminal system 240.

Referring back to step 640, if the new display request presented to the virtual graphics card 531 is for a digital video stream to be displayed then the virtual graphics card 531 proceeds to step 650. At step 650, the virtual graphics card 531 determines if the associated thin-client terminal system 240 includes the appropriate digital video decoder needed to decode the digital video stream. If the associated thin-client terminal system 240 does have the appropriate video decoder, then the virtual graphics card 531 proceeds to step 655 where the virtual graphics card 531 can send the video stream directly to the associated thin-client terminal system 240. This is illustrated on FIG. 5 as a direct line from virtual graphics card 531 to thin-client interface software 210 carrying “terminal compatible encoded video”. The thin-client interface software will encode the digital video for transmission to the thin-client terminal system 240. The recipient thin-client terminal system 240 will then use its local video decoder (262 or 263) to decode the video stream and render the digital video frames into the local screen buffer 260 of the thin-client terminal system 240.

Handling Unsupported Encoded Video Requests

Referring back to step 650 of FIG. 6, if the associated thin-client terminal system 240 does not have the appropriate video decoder then the virtual graphics card 531 in the thin-client server system 220 must determine another method of handling the video request. In the system disclosed in FIGS. 5 and 6, two different methods are presented for handling unsupported video streams. However, as will be seen neither method is fully satisfactory. The two methods are presented starting at step 660.

At step 660, the virtual graphics card 531 determines if transcoding of the unsupported video stream presented to the virtual graphics card 531 is possible and desirable. Transcoding is the process of converting a digital video stream from a first video encoding format into another video encoding format If transcoding of the video stream is possible and desirable, then the virtual graphics card 531 proceeds to step 665 where the video stream is provided to transcoder software 533 to transcode the video stream into an encoded video stream that is supported by the associated thin-client terminal system 240. Note that in some circumstances it may be possible to transcode a video stream but not desirable to do so. For example, transcoding can be processor intensive task and if the thin-client server system already has a heavy processing load then it may not be desirable to transcode the video stream. This may be true even if the transcoding is performed in lossy manner that reduces quality in order to perform the transcoding quickly.

Referring back to step 660, if transcoding is not possible or not desirable then the virtual graphics card 531 may proceed to step 670. At step 670, the virtual graphics card 531 sends the video stream to video decoder software 532 to decode the video stream. The video decoder software 532 will write the frames of video information into the appropriate screen buffer 215 for the associated application session 205. The frame encoder 217 of the thin-client server system 220 will read that bit mapped screen buffer 215 and transport that display information to the thin-client terminal system 240. Note that the frame encoder 217 has been designed to only transport changes to the screen buffer 215 to the associated thin-client terminal system 240. With full motion video, the changes may occur so frequently that updates may not be transmitted as fast as the changes are being made such that video displayed on the thin-client terminal system 240 may be missing many frames and appear jerky.

The system disclosed in FIGS. 5 and 6 will generally operate well if relatively static bit-mapped graphics are displayed or video streams supported by the associated thin-client terminal systems 240 are displayed. However, when encoded video streams that are not supported by the associated thin-client terminal systems 240 are presented, the systems must use one of two unsatisfactory systems for handling video streams that cannot be decoded in the thin-client terminal systems 240: the original system designed for relatively static graphics or digital video transcoding.

The original system is clearly inadequate since it was only designed to handle relatively static screen displays such as those created by simple office applications like word processors and spreadsheets. The resultant display at the thin-client terminal systems 240 may appear jerky and out of synchronization. Furthermore, the execution of the software decoder 532 will waste valuable processor cycles that could instead go to applications sessions 205. Finally, the inefficient encoding of the video information done by the frame encoder 217 would likely tax the bandwidth of the communication channel 230. Thus, use of the original system for full motion video is probably the least desirable solution.

The video transcoding option has similar problems. Various software developers have created software applications for transcoding a video stream from a first encoding system to another encoding system. For example, an MPEG encoded stream may be transcoded into a H.264 video stream. However, video transcoding is a very computationally intensive operation if it is to be performed with minimal quality loss. In fact, even with modern microprocessors, a good quality transcoding operation may require multiple times the duration of the video file. For example, transcoding an encoded video file of one hour with DVD quality encoded in MPEG-2 into an equivalent file encoded in H.264 encoding may take from one to five hours if good quality is maintained even using a Quad Core Intel CPU running at 2.6 GHz. Such high-quality non real-time video transcoding is not an option for a real-time terminal system as illustrated in FIG. 5. Real-time video transcoders will instead cut corners in order to operate in real-time such that the video quality will be reduced. And even with reduced video quality, real-time transcoders will consume a very large proportion of the processing power available in the thin-client server system 220.

Video Transcoding with Specialized Hardware

Video transcoding is a very specialized task that involves decoding an encoded video stream and then recoding the video stream in with an alternate video encoding system. Since different parts of a video image are generally not dependent upon each other, the task of transcoding lends itself to being divided and performed in parallel. Thus, the general purpose processor in a personal computer system is not the ideal system for transcoding. Instead, highly parallelized processor architectures are much better suited for the task of transcoding.

One type of highly parallelized processing architecture that is commonly available today is a Graphics Processor Unit (commonly referred to as a GPU). GPUs are specialized processors primarily designed for rendering three-dimensional graphical images in real-time within personal computer systems and videogame consoles. The GPU industry is currently dominated by nVidia, Inc. and ATI (a subdivision of Advanced Micro Devices). nVidia and ATI GPUs are designed with a large number of elementary processors on a single chip. Currently, state of the art nVidia graphics adapter cards have 240 processors also called stream processors. This large number of parallel processors will continue to grow in the future thus providing even better three-dimensional graphics rendering capabilities.

Due to their highly parallelized architecture, GPUs have proved to be very useful for performing compression for still images, full-motion video, and even audio. In comparison to the general purpose processor performing a transcoding operation of an hour of video data that may take 5 to 6 hours, the same transcoding operation may be performed by parallelized software running on a mid-range nVidia GPU in only 20 to 30 minutes. Since this is less than the one time length of the video, it can be performed in real-time. Allowing for some image quality degradation, the operation can be performed using even less of the GPU processing capabilities. And if this is performed within a system having a general purpose processor, that general purpose processor will be freed to operate on other tasks

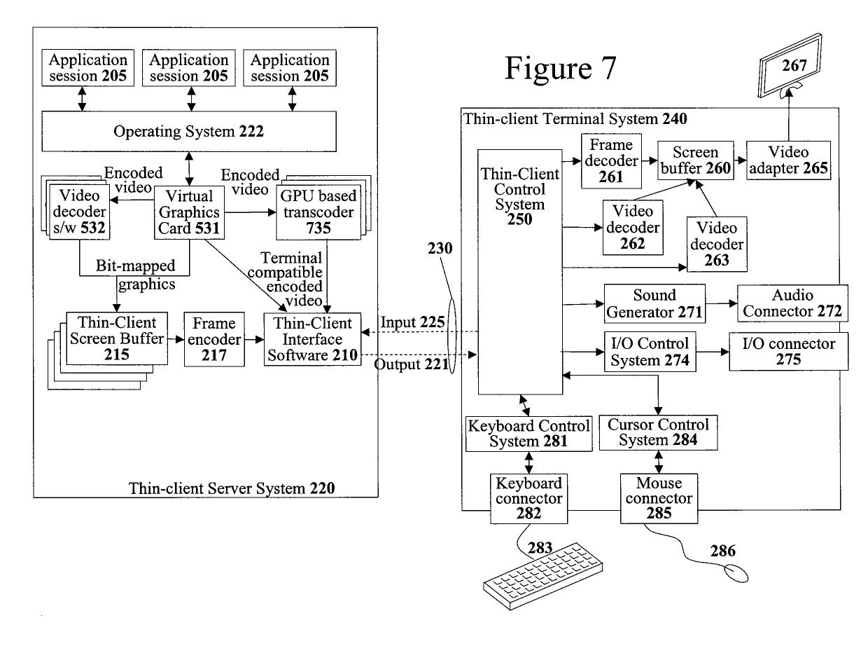

FIG. 7 illustrates an alternative implementation of a thin-client environment wherein a Graphics Processing Unit is being used to improve transcoding performance. Specifically, the video transcoding software 533 of FIG. 3 has been replaced with multiple GPU based transcoders 735. These GPU based transcoders 735 take advantage of the highly parallelized GPU hardware that is ideal for performing digital video processing tasks. Again, note that these transcoders 735 may be implemented as pairs of video decoders and video encoders. Ideally, both the video decoder and the video encoder would use the GPU. However, various embodiments may use the GPU only for decoding or only for encoding.

Referring back to step 660 in FIG. 6, when a video stream that is not supported by a thin-client terminal device has been presented, the system may proceed to step 665 wherein one of the GPU based transcoders 735 will be used to transcode the encoded video stream into a digitally encoded video stream that can be handled by the digital video decoder present in the target thin-client terminal system.

GPU Video Transcoding of Multiple Video Streams

The use of GPUs for transcoding has proven to be very effective. However, the system illustrated in FIG. 7 wherein a dedicated GPU is used to perform the transcoding will be expensive to implement. Ideally, more than one application session 205 should be able to share the same GPU for performing transcoding. However, the use of standard time-division multi-tasking has not proven to work effectively in environments where multiple video streams have to transcoded in real time. Although a GPU has the theoretical ability to do multiple streams at once, the video streams tend to become disrupted when a GPU processes more than one video stream.

One the difficult aspects of time-division multi-tasking is the penalty imposed when switching between the different tasks. Specifically, when switching between different tasks, the full state of the processor for the current task must be stored and the full state of the next task must be completely loaded before the processor can continue. In GPU processors which have a highly parallelized architecture with deep processor pipelines, such task switching penalties are especially severe. The deep pipelines of the GPU processor must be emptied out, stored, and then reloaded for a task switch to occur. Thus, to improve upon transcoding performance, the present disclosure propose.

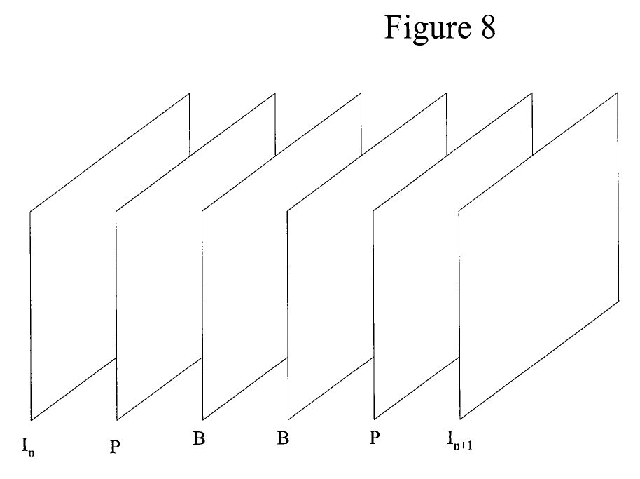

MPEG video encoding and its derivatives use a technique called intra-frame compression. While standards like MJPEG, DV and DVC compress frame by frame preserving each entire frame, the MPEG based standards only compress a few full independent frames called I-frames. The remaining frames are created by using information from other nearby frames. Specifically P-frames use information from other frames that previously occurred in the sequence and B-frames use information from frames that may occur before or after the current frame. Thus, between I-frames, MPEG standards create compressed frames (P-frames and B-frames) that contain only the changes between frames. An illustration of this is presented in FIG. 8. This method greatly increases compression without degrading quality since between two I frames the MPEG file will contain only “changes” from frame to frame and not the entire frame.

A problem with that technique is the inability to “cut” a video stream in its MPEG format at any arbitrary frame. Video editing applications accomplish such arbitrary cuts by decoding B-frames and P-frames and recoding those frames as I-frames. Specifically, all the frames in the time space between two I-frames can be fully decoded, creating all the original frames, cut and then re-encoded at that point. Applications such as hardware transcoding cannot do that since it would greatly impair the efficiency. Even if theoretically possible at the cost of reduced efficiency, it would greatly limit real-time applications. The inability to cut a stream at an arbitrary frame is part of the problem of doing multi-stream transcoding since it would greatly decrease the fixed time slot assigned to any stream for the hardware encoder.

To improve upon the art of multi-stream transcoding, the present disclosure introduces the idea transcoding multi-tasking based upon “chunks” of video defined by the existing I-frames in a video stream. The hardware encoder (either done with a GPU or a separate chip) receives a defined “chunk” of a video clip. The chunk is defined as two successive I-frames and all the other frames between those two I-frames. Task switching to the next chunk occurs after the current chunk is fully processed. In applications where the CPU does the actual decoding and raw uncompressed frames are passed to the hardware encoder for final compression, the CPU would pass a number of full frame equivalents to the number of frames included in a final chunk. This enables the hardware encoder to quickly compress that chunk and then switch to the next chunk. Over time, the series of chunks can be from any of the multiple active streams; whichever is next in line at the time that the hardware encoder is ready for the next chunk.

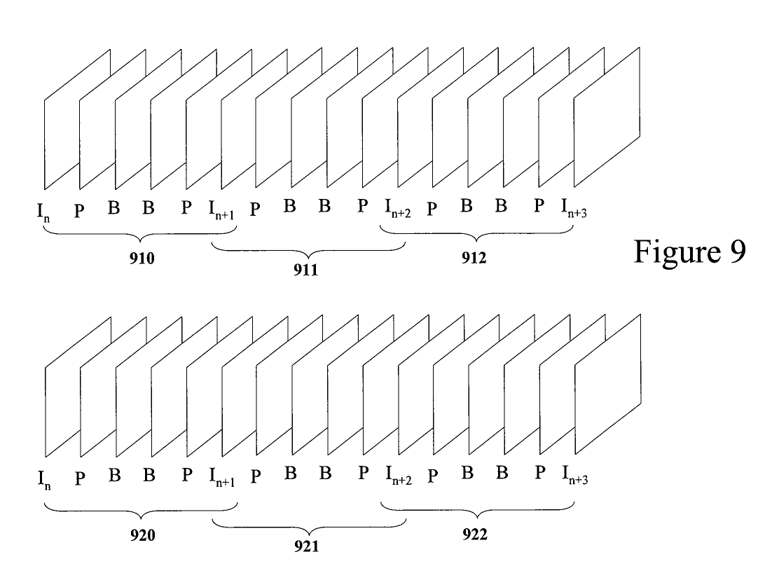

FIG. 9 illustrates an example of how the chunk-based transcoding multi-tasking may operated. FIG. 9 conceptually illustrates two independent MPEG type encoded video streams. To perform chunk-based transcoding multi-tasking, the video streams are divided into chunks and then processed in those chunks. In FIG. 9, a first chunk 910 from the first video stream would processed first. A task switch to the lower video stream would occur and process chunk 920. After processing chunk 920, a task switch to another video stream would occur. If there are just the two video streams, the system would task switch back to the first video stream such that chunk 911 would then be processed. After that, chunk 921 would be processed, and so on. The frames will be encoded with timestamps such that the frames can be reconstructed and played back at the proper rate.

The video chunks will be compressed at a speed better than real time and then deposited in a stream buffer where they will rebuilt with the following video chunk without losing any video frames. The video chunks will be then streamed to the final destination at real-time speed.

Combined System with 3D Graphics and GPU Video Encoding

The teachings presented in the earlier sections may be combined to created a server system that uses specialized graphics hardware in the server system for performing both 3D graphics rendering and digital video encoding. In order to create such a system, the software for managing the sharing of the graphics hardware must be able to handle both 3D graphics rendering and digital video encoding tasks in its context switching architecture. Such context switching is well known in the art since most modern computer operating systems perform context switching in order to handle multiple applications running simultaneously on the same computer hardware.

The preceding technical disclosure is intended to be illustrative, and not restrictive. For example, the above-described embodiments (or one or more aspects thereof) may be used in combination with each other. Other embodiments will be apparent to those of skill in the art upon reviewing the above description. The scope of the claims should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. §1.72(b), which requires that it allow the reader to quickly ascertain the nature of the technical disclosure. The abstract is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

What is claimed is:

1. A method of transcoding multiple streams of video information, said method comprising:
accessing a first video stream;
transcoding from a first intra-frame to a next infra-frame;
saving process state;
accessing a next video stream; and
repeating said steps of transcoding, saving, and accessing.

2. The method of transcoding multiple streams of video information as set forth in claim 1, said method further comprising:
transmitting the transcoded video to a remote terminal system.

3. The method of transcoding multiple streams of video information as set forth in claim 2 wherein said transcoded video is decoded by a video decoder in said remote terminal system.

4. The method of transcoding multiple streams of video information as set forth in claim 1 wherein said transcoding is performed by a graphics processing unit (GPU).

5. The method of transcoding multiple streams of video information as set forth in claim 1 wherein said video streams are associated with multiple different users supported by a single server system.

6. A server system for serving multiple users, said server system comprising:
a processor and a memory system;
a terminal server module for handling multiple terminal sessions;
a first virtual graphics adapter for handling display requests from a first terminal session;
a first transcoder, said first transcoder receiving a display request comprising a first video stream, said first transcoder transcoding from a first intra-frame to a next infra-frame of said video stream and then saving a process state, said first transcoder accessing a second video stream from a second terminal session and repeating said actions of transcoding, saving, and accessing.

7. The server system for serving multiple users as set forth in claim 6, said server system further comprising:
an interface module for transmitting said transcoded video to a remote terminal system.

8. The server system for serving multiple users as set forth in claim 7 wherein said transcoded video is decoded by a video decoder in said remote terminal system.

9. The server system for serving multiple users as set forth in claim 6 wherein said transcoding is performed by a graphics processing unit (GPU) in said server system.

10. The server system for serving multiple users as set forth in claim 5 wherein said video streams are associated with different users supported by said server system.

11. A method of rendering graphics in a multi-user environment, said method comprising:
creating a first terminal session in a server;
creating a first virtual 3D graphics card for the first terminal session;
assigning a share of physical graphics accelerator device to the first virtual graphics card; and
rendering a virtual desktop using the first virtual graphics card in a frame buffer.

12. The method as set forth in claim 11 wherein said share of the physical graphics accelerator device comprises a time slice.

13. The method as set forth in claim 11 wherein said share of the physical graphics accelerator device comprises a thread running on said physical graphics accelerator device.

14. The method of rendering graphics in a multi-user environment as set forth in claim 9, said method further comprising:
transmitting the virtual desktop to a remote terminal system.

15. A server system for serving multiple users, said server system comprising:
a processor and a memory system;
a physical graphics accelerator device;
a terminal server module for handling multiple terminal sessions; and
a first virtual 3D graphics card for the first terminal session, said first virtual 3D graphics card being assigned a share of physical graphics accelerator device, said first virtual 3D graphics card rendering a virtual desktop using the first virtual 3D graphics card in a first frame buffer.

16. The method as set forth in claim 15 wherein said share of the physical graphics accelerator device comprises a time slice.

17. The method as set forth in claim 15 wherein said share of the physical graphics accelerator device comprises a thread running on said physical graphics accelerator device.

18. The method of rendering graphics in a multi-user environment as set forth in claim 15, said method further comprising:
transmitting the virtual desktop to a remote terminal system.

19. A server system for serving multiple users, said server system comprising:
a processor and a memory system;
a physical graphics accelerator device;
a terminal server module for handling multiple terminal sessions;
a first virtual 3D graphics card for the first terminal session, said first virtual 3D graphics card being assigned a share of physical graphics accelerator device, said first virtual 3D graphics card rendering a virtual desktop using the first virtual 3D graphics card in a first frame buffer; and
a first transcoder, said first transcoder receiving a display request comprising a first video stream, said first transcoder transcoding from a first intra-frame to a next infra-frame of said video stream and then saving a process state, said first transcoder accessing a second video stream from a second terminal session and repeating said actions of transcoding, saving, and accessing.
